(19) United States
(12) Patent Application Publication
(10) Pub. No.: US 2011/0131336 A1
(43) Pub. Date: Jun. 2, 2011

(54) METHOD AND DEVICE FOR FILE TRANSMISSION BASED ON MULTIPLE PROTOCOLS

(75) Inventors: Wenyu Wang, Shanghai (CN); Yifei Wang, Shanghai (CN); Wei Zhu, Shanghai (CN)

(73) Assignee: SYNACAST COMPUTER SYSTEM (SHANGHAI) CO., LTD., Shanghai (CN)

(21) Appl. No.: 12/955,697

(22) Filed: Nov. 29, 2010

(30) Foreign Application Priority Data
Dec. 1, 2009 (CN) 200910199799.0

(51) Int. Cl. G06F 15/16

(52) U.S. Cl. 709/228; 709/230

(57) ABSTRACT

The present invention relates to method and device for file transmission based on multiple protocols. According to an embodiment of the present invention, there is provided a method in a user node of downloading files, comprising the steps of: A. intercepting a request message from an application functional entity, for requesting a file based on a first protocol; B. downloading said file at least based on a second protocol; C. providing said file to said application functional entity. With the method, software, storage media provided in the present invention, faster download speed could be obtained when the client downloads files from the network base on the first protocol, compared with that obtained in the traditional C/S mode, therefore the user experience is improved.

### FIELD OF THE INVENTION

The invention relates to a network telecommunication technology, and particularly to the P2P technology.

### BACKGROUND OF THE INVENTION

The traditional download of files from network applies client-server (C/S) architecture, and is usually based on Hyper Text Transport Protocol (HTTP) or File Transport Protocol (FTP), the download speed is restricted by the data handling capacity of the server, if the amount of active users is huge, the average download speed of the users decreases dramatically, which affects user experience seriously.

### SUMMARY OF THE INVENTION

In recent years, services that provide file download via P2P technology are widely used. The commonly used protocols based on P2P technology comprise: bt protocol, ed2k protocol, kad protocol, etc. Higher download speed can be obtained by adopting P2P technology, compared with that obtained in C/S mode.

In order to overcome the problems in the prior arts, the invention provides a technical solution of downloading files based on multiple protocols.

According to a first aspect of the present invention, there is provided a method in a user node of downloading files, comprising the steps of: A. intercepting a request message from an application functional entity, for requesting a file based on a first protocol; B. downloading said file at least based on a second protocol; C. providing said file to said application functional entity.

According to an embodiment of method of downloading files in the present invention, said request message comprises the location information of said file; said step B further comprises: B1. querying a first server, so as to determine the identity information of said file according to said location information of said file;

B2. downloading said file according to said identity information of said file based on P2P technology in a P2P network.

According to an embodiment of method of downloading files in the present invention, said step B2 further comprises: B21. querying a second server according to said identity information of said file, so as to obtain the addressing information of other nodes that possess said file; B22. if other P2P nodes that possess the file exist, downloading said file from said other P2P nodes according to said addressing information, based on P2P technology.

According to an embodiment of method of downloading files in the present invention, said first protocol comprises Hyper Text Transport Protocol or File Transport Protocol, said second protocol comprises protocols based on P2P technology.

The above mentioned methods can increase the speed of downloading files in many conditions, so as to greatly improve the user experience. Besides, it is admired for those service providers that suffer from the technology of stealing links that the method provides the user the experience that the download is finished by the application functional entity that initiates the request.

According to another aspect of the present invention, there is provided a downloading device in a user node for file download, comprising: a first obtaining means configured to intercept a request message from an application functional entity, for requesting a file based on a first protocol; a first means configured to download said file at least based on a second protocol; a first providing means, configured to provide said file to said application functional entity.

According to another aspect of the present invention, there is provided a software program for client, comprising instructions for implementing each step of the above method.

According to another aspect of the present invention, there is provided a storage media for storing the instructions for implementing each step of the above method.

Via using the method, device, software and storage media provided by the present invention, faster download speed could be obtained when the client downloads files from the network base on the first protocol, compared with that obtained in the traditional C/S mode, therefore the user experience will be improved.

### BRIEF DESCRIPTION OF THE DRAWINGS

Other features, aspects and advantages of the present invention will become obvious by reading the following description of non-limiting embodiments with reference to the appended drawings. The elements in the drawings are not necessarily drawn to scale. Same or similar reference numerals refer to the same or similar steps or means.

FIG. 1 shows the network topology according to an embodiment of the present invention;

FIG. 2 shows the flowchart of a method in a user node of downloading files according to an embodiment of the present invention;

FIG. 3 shows the flowchart of a step of the method of downloading files according to an embodiment of the present invention;

FIG. 4 shows the flowchart of a sub-step of the method of downloading files according to an embodiment of the present invention;

FIG. 5 shows the flowchart of signal traversing in the process of downloading files according to an embodiment of the present invention;

FIG. 6 shows the block diagram of a downloading device according to an embodiment of the present invention.

### DETAILED DESCRIPTION OF EMBODIMENTS

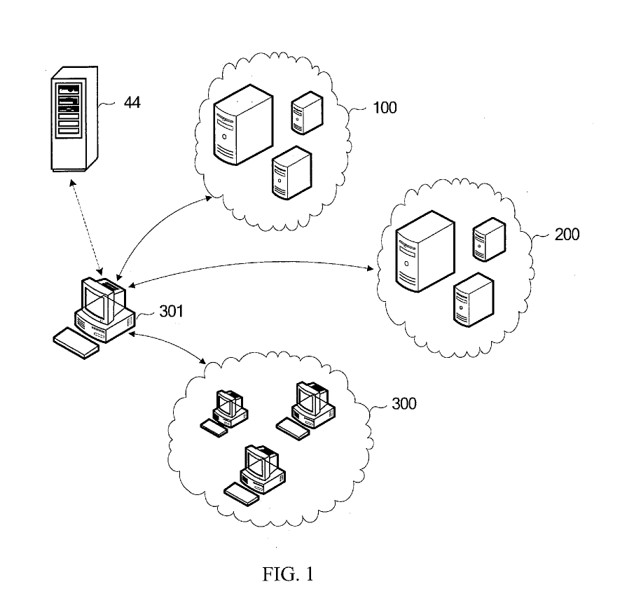

FIG. 1 shows the network topology according to an embodiment of the present invention. As shown in the FIG. 1, the network comprises a group 100 of first server, a group 200 of second server, a P2P client network 300 and a server 55 that provides files to download. A user equipment 301 is a component of the P2P client network 300.

The first server group 100 comprises at least one first server, in this specification, each first server is represented by a natural number in 100˜200, for example, 101, 199, etc.

The second server group 200 comprises at least one second server, in this specification, each second server is represented by a natural number in 200˜300, for example, 201, 299, etc.

The P2P client network 300 is composed of user equipments that install and run the client software provided by the present invention. Each of such user equipments is represented by a natural number in 300˜400, for example 301, 399, etc.

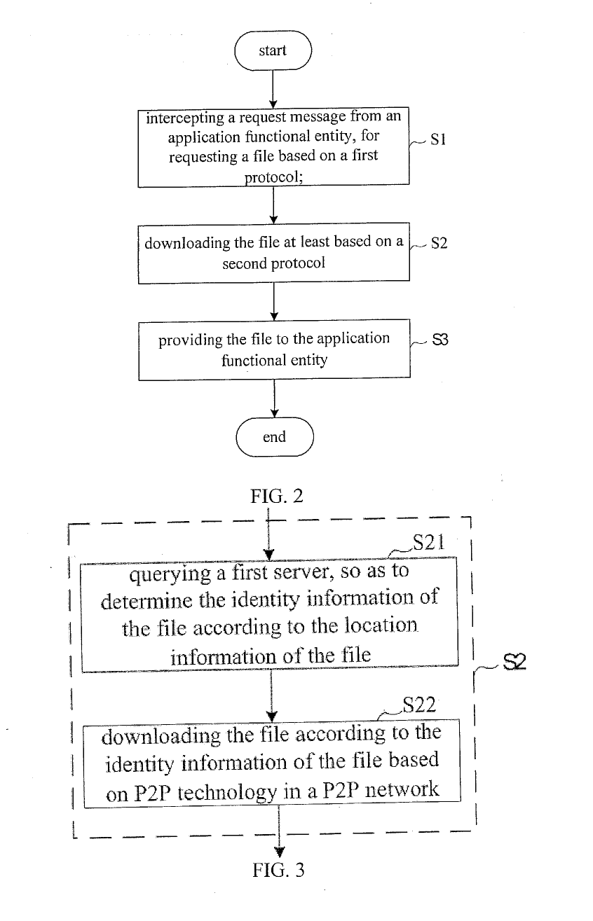

FIG. 2 shows the flowchart of a method in a user node of downloading files according to an embodiment of the present invention. As shown in FIG. 2, the method comprises three steps S1, S2 and S3. The method of the embodiment will be described in conjunction with FIG. 1 and FIG. 2.

For example, the user equipment 301 runs two software program 55 and 66 (not shown in the FIG.s), wherein software program 55 is used to download and use the files from the network, such as but not limited to media player embedded in the browser page, which is used to download and play the media files from the network. For example, but not restrictively, the server 44 provides services such as file download, on-demand video files. Usually, the file download service adopting C/S architecture is based on a first protocol, and the first protocol can be Hyper Text Transport Protocol (HTTP protocol) or File Transport Protocol (FTP protocol). When the user that uses the user equipment 301 requests to view a video file 71 (not shown) in server 44 on demand via the software program 55, the software program 55 will send a request message based on the first protocol, for requesting the video file 71. Due to the restriction on bandwidth, download payload of the server 44, etc., the download speed of the file 71 may be slow. Particularly for services such as on-demand video or live video, situations such as interruption or waiting often occur, therefore, the user experience is affected worse. The software program 66 is the client software provided in the present invention, which can be used to accelerate the download carried out by the software program 55. Each step of the method of downloading files in the embodiment is carried out by the terminal equipment 301 via running the software program 66. In the following description, terminologies such as the user equipment, terminal, client terminal, user node, all refer to the client that install and run the client software 66 provided in the present invention, unless otherwise stated. In the following description, the case that the user equipment 301 downloads file 71 via running the software program 66 will be taken as an example.

In step S1, the user node 301 runs the software program 66 and intercepts a request message from the software program 55 for requesting the file 71 based on the first protocol.

To be specific, the user node 301 can detect all the outwards request message based on the first protocol, and intercept those request messages requesting contents of a specific type, such as video file.

In step S2, the user node 301 downloads the file 71 at least based on the second protocol. The second protocol here comprises protocol based on P2P techniques, that is to say, the client terminal 301 will download the file 71 via the software program 66 in the P2P client network 300. Besides, the software program 66 can download the file 71 from server 44 or other servers that possess the file 71 based on the first protocol. In this manner, when the P2P client network 300 can provide the download of the file 71, the speed of the client terminal 301 to download file 71 is higher, in some situations even several times higher, than the speed of downloading files 71 from the server only based on the first protocol.

In step S3, the user node 301 provides the contents of file 71 downloaded via running the software program 66 to the software program 55, and the downloaded contents are stored in the storage. For example, the downloaded contents of file 71 can be stored in the Random Access Memory (RAM) and/or Read Only Memory (ROM), and the software program 55 can read the data stored in the memory and play the obtained contents of file 71.

Usually, the request message from the software program 55 for requesting the file 71 comprises the location information of the file 71, such as the Uniform Resource Locator (URL) of the file 71. In step S2, the user node 301 downloads the file 71 from the P2P client network 300 according to the URL. The address bar of the browser which the software program 55 is embedded into still displays the URL of the file 71 in server 44, therefore, the user experience that all the downloaded file data is from the server 44. Thus, it will not bring any damage to the benefit of the service provider that possesses the server 44 and provides corresponding services. Therefore, for all kinds of video website or downloading service provider of network file of other types, the extensive use of the software program 66 is welcome, at least not rejected.

According to an embodiment of the present invention, the partition of the files during downloading is characterized by: each of the files is partitioned into one or more blocks according to the feature of a first protocol, such as the feature of HTTP protocol; each block comprises a plurality of pieces of the same size; and each piece comprises a plurality of subpieces of the same size. To be specific, the size of the subpiece can be for example 1KB, that is to say, 1000 Byte, and the download based on P2P technology is conducted in subpieces. The size of the piece can be 128KB, and the download of files based on the first protocol from the server 44 or other servers is conducted in pieces. Each block comprises a plurality of pieces, therefore its size is integer multiple of the piece, for example, the size of the block can be 2MB. Usually, the partition to a file starts from the header of the file and is carried out block by block. Therefore, the last block of the file may be smaller, and the blocks except the last one have the same size. Those skilled in the art should understand, the above sizes of block, piece and subpiece are all exemplary and are non-restrictive.

FIG. 3 shows the flowchart of a step of the method of downloading files according to an embodiment of the present invention. As shown in FIG. 3, in the embodiment, the above mentioned step S2 can further comprise substep S21 and substep S22.

In substep S21, the user node 301 queries the first server group 100 according to the location information of the file 71, such as its URL, so as to determine the identity information of the file 71.

In substep S22, the user node 301 downloads the file 71 in P2P network 300 based on P2P technology according to the identity information of the file 71.

To be specific, the identity information can be the Resource Identity (RID) of the file, that is, the digital abstract of the whole file. In the following description, the following terminologies, such as digital abstract, digital abstract value and digital fingerprint, are interchangeable, unless otherwise stated. Usually, the digital abstract of the file is the result of conversion to the files using hash functions, for example, MD5 function or SHA1 function. Since the digital abstract value is of good one-to-one correspondence with the file content, it is commonly used as the search term in P2P technology.

The first server group 100 is used for searching files. The index information stored in the first server group 100 comprises one or more of the following items: the index from the location information, such as URL, to the identity information, such as RID, the index from the identity information to the location information, the index from the digital abstract value of the content of a predetermined length of the file header and the file length to the identity information.

According to an embodiment of the present invention, the information stored in the first server group 100 may also comprise the digital abstract value of each block of the file, these digital abstract values are associated with the identity information of the file, i.e. RID, or the location information, i.e. URL.

In step S21, the user node 301 queries the first server group 100, so as to determine the digital abstract value of each block of the file 71 as well as the identity information of the file 71.

In step S22, the user node 301 downloads the file 71 based on P2P technology in the P2P network 300, wherein the user node 301 verifies the accuracy of each downloaded block according to the determined digital abstract value of each block. If the verification passes, the user node 301 stores the downloaded block, and continues the download until the whole file 71 is downloaded.

The correspondence between a file and the location information, such as the URL, stored in the server 44 may vary over time, so that the index information from the location information of the file to the identity information of the file or the digital abstract value of each block stored in the first server group 100 may be wrong. Therefore, in step S22, error may occur when the user node 301 verifies each downloaded block according to the digital abstract value of each block obtained by query, that is, the digital abstract value calculated according to the downloaded block does not match the digital abstract value of the block obtained by query. The user node 301 carries out the verification on each downloaded block, when the amount of the blocks with mismatch reaches a predetermined value, such as 5, the user node 301 will abandon the download in P2P network, since the index information stored in the first server group 100 is determined as wrong. Then, the user node 301 will download the whole file 71 all over again from the server 44 according to the location information of the file 71, and update the identity information and the digital abstract value of each block according to the newly downloaded file 71, and report the updated information to the first server group 100. The first server group 100 will update the stored index information according to the information.

According to an embodiment of the present invention, the first server group 100 stores the index information from the digital abstract value of the content of a predetermined length of the file header and the file length to the identity information. The step S2 of the method of downloading files conducted by the user node 301 via the software program 66 comprises: downloading the content of a predetermined length of the file header from the server 44 according to the location information, determining the digital abstract value of the header content as well as the file length, and querying the first server according to the digital abstract value of the header content and the file length, so as to determine the identity information of the file 71. Usually, such operation occurs in the situation that the location information of the file and the file content do not match or their correspondence changes.

According to an embodiment of the present invention, the first server group 100 can be divided into multiple clusters, the index information stored in each cluster of the first servers is associated with distinguishing files, and each cluster of the first servers comprises at least one first server. For example, the first server group 100 comprises two clusters, the first cluster comprises a first server 101, and the second cluster comprises a first server 102. A method of dividing the index information is as follows: calculating the result modulus value of the digital abstract value of the file modulo n, wherein n represents the amount of clusters of the first server group 100; the index information associated with the digital abstract value whose result modulus value equals to 0 is stored in the first cluster of the first server; the index information associated with the digital abstract value whose result modulus value equals to 1 is stored in the second cluster of the first server; and so on, and the index information associated with the digital abstract value whose result modulus value equals to n−1 is stored in the n-th cluster of the first server. In this manner, the index information related to all the files is evenly stored in each cluster of the first server, therefore the payload of a single first server is reduced, and the whole first server group 100 takes the responsibility of query of the index information. Those skilled in the art should understand, the manner of partition of the first server group 100 into multiple clusters, the amount of servers in each cluster, and the storage of the index information in clusters are all exemplary and are non-restrictive.

According to an embodiment of the present invention, the operation executed by the software program 66 running in the user node 301 further comprises the following step: determining the identity information and other related information of the file 71, such as the location information of the file 71, the digital abstract value of the content of a predetermined length of the header of the file 71 and the length information of the file 71, etc, and providing the information to the first server group 100. The first server group 100 establishes kinds of index relationship related to file 71 according to the above information. Usually, the step often occurs when the user node 301 is the first user to request to download the file 71, since the first server group 100 does not store any index information related to file 71 at that time. It is self-evident that before the user node 301 executes the step, the method further comprises: intactly downloading the file 71 according to the location information of the file 71 in the request message. Since there is no existing index relationship for search, the complete file 71 is needed to determine the identity information of the file 71 and other related information.

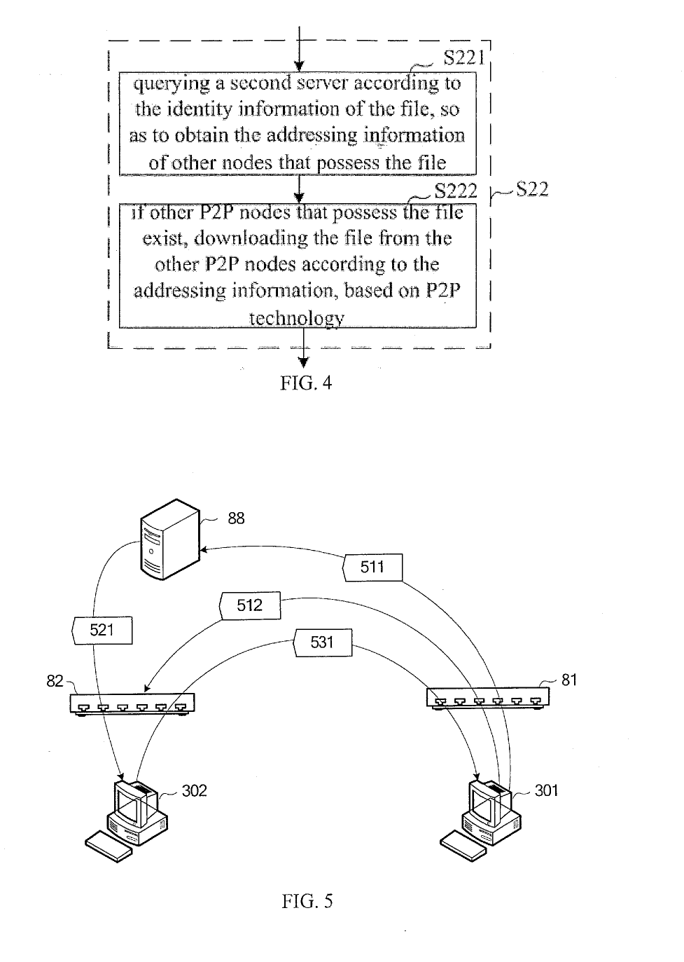

FIG. 4 shows the flowchart of a sub-step of the method of downloading files according to an embodiment of the present invention. As shown in FIG. 4, in the embodiment, the above-mentioned step S22 can further comprises sub-steps S221 and S222.

In sub-step S221, the user node 301 queries the second server group 200 according to the identity information of the file 71, such as the digital abstract value of the whole file, so as to obtain the addressing information of other node that possesses the whole or part content of the file 71.

In sub-step S222, if other nodes that possess the whole or part content of the file 71 exist, the user node 301 downloads the file 71 from these other nodes according to the addressing information, based on P2P technology.

The second server group 200 is used for user indexing, and it stores the user index table related to the files. The user index table related to a file comprises the identity information of the file and the addressing information of the user nodes that possess the whole or part of the contents of the file. The user node 301 indexes other user nodes that possess the file 71 in the P2P client network 300 via the second server group 200 and carries out the download according to the result of the indexing.

According to an embodiment of the present invention, the second server group 200 is divided into multiple clusters, each cluster of the second servers is used to index the user node that possess distinguishing files respectively. To be specific, the amount of clusters of the second servers can be equal to that of the first severs, and each cluster of the second servers corresponds to a cluster of first servers respectively. The dividing of the user index table in the second server can apply the same dividing method as that for the index information in the first server, for example, calculating the result modulus value of the digital abstract value of the file modulo n, wherein n represents the amount of clusters of the second server group 200; the user index table associated with the file whose result modulus value of the digital abstract value equals to 0 is stored in the first cluster of the second server; the user index table associated with the file whose result modulus value of the digital abstract value equals to 1 is stored in the second cluster of the second server; and so on, and the user index table associated with the file whose result modulus value of the digital abstract value equals to n−1 is stored in the n-th cluster of the second server. In this manner, the user index tables of all the files are evenly stored in each cluster of the second servers, therefore the payload of a single second server is reduced, and the whole second server group 200 takes the responsibility of user indexing.

Each cluster may comprise a plurality of second servers. For example, the first cluster of the second servers comprises servers 201, 202 and 203, which correspond to the first cluster of first servers; the second cluster of the second servers comprises servers 211, 212 and 213, which correspond to the second cluster of first servers; and the n-th cluster of the second servers comprises servers 2(n−1)1, 2(n−1)2 and 2(n−1)3, etc. For the first cluster of the second servers, each sever 201, 202 and 203 therein can be set in different network areas; therefore, the user node resides in one network area may preferably choose to query the second server in the area for the user index table, so as to save the resources of the whole network. Other clusters of second server can apply similar configuration.

Since the files possessed by the user node change with time, correspondingly, the user index table in the second server group 200 may need to be updated with time.

One feasible solution is that each user node reports to the second server the identity information of the files that it possesses termly or periodically. Wherein, all the files in the user node are divided according to the same dividing method as that in the second server, and the user node reports the information related to the existence and update of each cluster of files to each cluster of the second servers. For example, the user node 301 possess the complete or part of the contents of file 71 to file 75, wherein the user index tables of files 71, 73 and 75 are stored in the first cluster of the second servers, and the user index tables of files 72 and 74 are stored in the second cluster of the second servers; the user node 301 can select a second server from the first cluster, such as 201, and select a second server from the second cluster, such as 211, and reports periodically to the two selected second servers; the reported contents may comprise the identity information of the files that belong to the cluster and are possessed by the user node 301, for example, the report sent to the second server 201 comprises the digital abstract values of files 71, 73 and 75, and the report sent to the second server 211 comprises the digital abstract values of files 72 and 74. The second server maintains and updates its stored user index tables according to the received report.

Preferably, each user node periodically reports to the second server the variation of the files that it possesses, which is, reporting the increment. For example, the user node 301 possesses files 71, 73 and 75 for a long term, and the report sent to the second server 201 may only indicates that the files are unchanged; if the file 71 in the user node 301 is deleted, the report sent to the second server 201 next time only needs to indicate that the file 71 has been deleted; if the user node 301 add a file 77 that belongs to the first cluster, the report sent to the second server 201 next time only needs to indicate that the file 77 has been added; the above variation information can comprise the digital abstract value of the file and a related identifier that indicates addition/delete, for example, number 0 or 1. The second server carries out the maintenance or update according to the received variation information and the stored user index table. When the amount of the files that the user node possesses is big, the method of reporting the increment can remarkably decrease the overhead for report. When the user node 301 reports to the selected second server in a cluster of the second servers, such as the second server 201 in the first cluster, the information reported by the user node 301 and the contents of the user index table stored in the second server 201 may not match each other and error occurs, when the duration for the continuous errors has exceed a predetermined duration, the user node 301 may reselect a second server from the first cluster, for example, second server 202, and reports to server 202 the identity information or variation information of the files that belong to the second cluster and are possessed by the user node.

Those skilled in the art should understand that, the report manner of the user node and the manner for updating the user index table in the second server are all exemplary and are non-restrictive.

FIG. 5 shows the flowchart of signal traversing in the process of downloading files according to an embodiment of the present invention. As shown in FIG. 5, in this embodiment, there is a second user node 302, which is an intranet user and is connected to the wide area network (WAN) via the network address translation (NAT) server 82, and the server 88 is the stun server related to the user node 302. Similarly, the user node 302 is an intranet user, and is connected to the WAN via the NAT server 81.

The addressing system of the initial interne is that each node has a unique and unchanged global address, and the node can communicate with any other node via the address. However, up to now, such addressing system is substituted by the new widely used address system. The new addressing system is composed of global address field and huge private address field accessing to the global address field via the NAT. In the new addressing system, only the nodes in the global address field can easily communicate with any other node possessing global address in the network, because the node possesses global, unique and routable address. The nodes in the private network, that is, intranet user, can communicate with other nodes in the same private network, and usually have the capacity of initiating TCP connection or sending UDP data packets to the nodes with the global address. The NAT devices play the role of allocating temporary forward session to the node that initiates connection from the intranet to the public network, and converting the endpoint, including address and port, of the data packet from the intranet to the endpoint of the public network, and converting the endpoint of the data packet from the public network to the endpoint of the intranet, and filtering the unauthorized data packet from the public network.

In order to allow the access from the WAN, the user node 302 can select a node with global address, such as the stun server 88, and informs the stun server 88 of the endpoint of intranet of the user node 302, 10.0.0.1:7777 for example, and the endpoint of the public network of NAT server 82 related the user node 302, 222.0.0.1:8888 for example. The user node 302 may termly sends the packet to the stun server 88, for example, every 15 seconds; the stun server 88 can feedback packets to the user node 302 with a longer interval, for example, every two minutes; therefore, the stun connection can be maintained. In this manner, the access to the second user node 302 from the WAN could be allowed via the forwarding of the stun server 88. The addressing information that the user node 302 reports to the second server group 200 and is stored in the second server group 200 comprises: the endpoint of intranet of the user node 302, the endpoint of the public network of the NAT server 82 and the endpoint of the stun server 88, 200.0.0.8:9000 for example.

Alternatively, the stun server 88 selected by the user node 302 is a user node with global address, and is equipped with the software program 66 provided by the present invention and runs it.

The user node 301 runs the software program 66, and uses an endpoint of intranet, 10.0.0.2:7007 for example, to communicate with others. The user node 301 get access to the WAN via an endpoint of public network of the NAT server 81 related to the endpoint of intranet, 233.0.0.1:8000 for example.

In the aforementioned step S221, the user node 301 can index the addressing information of the user node 302 from the second server group 200. The user node 301 downloads the file 71 from the P2P network, for example, it downloads contents of the file 71 from the user node 302.

Firstly, the user node 301 will send a message 511 to the stun server 88 for requesting to establish P2P connection with the user node 302. The message 511 should comprise the endpoint of intranet of the user node 302, 10.0.0.1:7777 for example, and the endpoint of the public network of the related NAT server, 222.0.0.1:8000 for example. Then, the stun server 88 will send a message 521 to the user node 302. The message 521 comprises the addressing information of the user node 301. After receiving the message, the user node 302 is aware that the user node 301 tries to establish connection with it.

Then, the user node 302 will send a message 531 to the user node 301 for requesting to establish connection with the user node 301.

If the user node 301 is a user of public network, or the path from the endpoint 222.0.0.1:8000 of the public network of the NAT server related to the endpoint 10.0.0.1:7777 of intranet of the user node 302 to the user node 301 is open, the user node 301 can receive the message 531. Then, the connection between the user nodes 301 and 302 is established, and the user node 301 can download the contents of the file 71 from the user node 302.

In the embodiment, the user node 301 is an intranet user, and the path from the endpoint 222.0.0.1:8000 of the public network of the NAT server related to the endpoint 10.0.0.1:7777 of intranet of the user node 302 to the user node 301 is not open, the NAT server 81 may discard the message 531, and the connection between the user node 301 and 302 still can not be established. Preferably, when the user node 301 sends the message 511 to the stun server 88, meanwhile, it also sends a handshake message 512 to the NAT server 82, the message 512 comprises the endpoint of the public network of the NAT server 82, i.e. 222.0.0.1:8000, so as to set up the connection between the endpoint of the public network and the user node 301. Then, when the user node 302 sends the message 531 via the endpoint of the public network of the server 82, the NAT server 81 will forward the message 531 to the user node 301 via the open connection. Therefore, the connection between the user node 301 and user node 302 is established, and the user node 301 can download content of the file 71 from the user node 302.

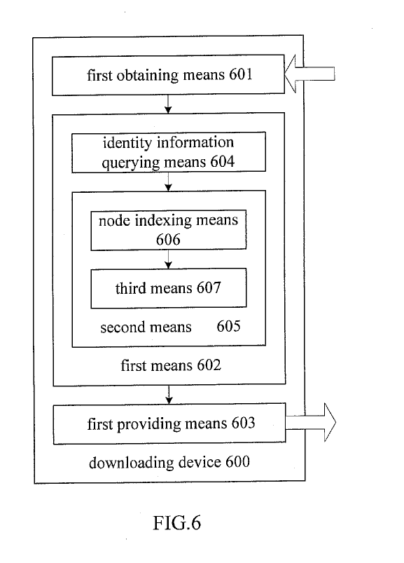

FIG. 6 shows the block diagram of a downloading device according to an embodiment of the present invention. As shown in FIG. 6, the downloading device 600 comprises: a first obtaining means 601, a first device 602, a first providing means 603. The downloading device of the embodiment will be described in conjunction with FIG. 1, FIG. 2 and FIG. 3.

For example, the user equipment 301 runs software program 55 which is used to download and use the files in the network, such as but not limited to media player embedded in the browser page, which is used to download and play the media files in the network. For example but not restrictively, the server 44 provides services such as file download, on-demand video files. Usually, the file download service based on C/S architecture is based on a first protocol, and the first protocol can be Hyper Text Transport Protocol (HTTP protocol) or File Transport Protocol (FTP protocol). When the user that uses the user equipment 301 requests to view a video file 71 (not shown in the FIG.s) in server 44 on demand via the software program 55, the software program 55 will send a request message based on the first protocol, for requesting the video file 71. The downloading device 600 is usually installed at the user equipment, the user node 301 for example, and the downloading device 600 can accelerate the download carried out by the software program 55. In the following description, the case that the downloading device 600 in the user equipment 301 downloads file 71 will be taken as an example.

The first obtaining means 601 is used to intercept a request message from the software program 55 for requesting the file 71 based on the first protocol.

To be specific, the first obtaining means 601 can detect all the outwards request message based on the first protocol, and intercept those request messages requesting contents of a specific type, such as video file.

The first means 602 downloads the file 71 at least based on the second protocol. The second protocol here comprises protocol based on P2P techniques, that is to say, the first means 602 will download the file 71 in the P2P client network 300. Besides, the first means 602 can download the file 71 from server 44 or other servers that possess the file 71 based on the first protocol. In this manner, when the P2P client network 300 can provide the download of the file 71, the speed of the client terminal 301 to download file 71 is higher, in some situations even several times higher than the speed of downloading files 71 from the server only based on the first protocol.

The first providing means 603 is used to provide the downloaded contents of file 71 to the software program 55, and the downloaded contents are stored in the storage. For example, the downloaded contents of file 71 can be stored in the Random Access Memory (RAM) and/or Read Only Memory (ROM), and the software program 55 can read the data stored in the memory and play the obtained contents of file 71.

Usually, the request message from the software program 55 for requesting the file 71 comprises the location information of the file 71, such as the Uniform Resource Locator (URL) of the file 71. The user node 301 downloads the file 71 from the P2P client network 300 according to the URL. The address bar of the browser which the software program 55 is embedded into still displays the URL of the file 71 in server 44, therefore, the user experience that all the downloaded file data is from the server 44. Thus, it will not bring any damage to the benefit of the service provider that possesses the server 44 and provides corresponding services. Therefore, for all kinds of video website or downloading service provider of network file of other types, the extensive use of the downloading device 600 is welcome, at least not rejected. According to an embodiment of the present invention, the partition of the files during downloading is characterized by: each of the files is partitioned into one or more blocks according to the feature of a first protocol, such as the feature of HTTP protocol; each block comprises a plurality of pieces of the same size; and each piece comprises a plurality of subpieces of the same size. To be specific, the size of the subpiece can be for example 1KB, that is to say, 1000 Byte, and the download based on P2P technology is conducted in subpieces. The size of the piece can be 128KB, and the download of files based on the first protocol from the server 44 or other servers is conducted in pieces. Each block comprises a plurality of pieces, therefore its size is integer multiple of the piece, for example, the size of the block can be 2MB. Usually, the partition to a file starts from the header of the file and is carried out block by block. Therefore, the last block of the file may be smaller, and the blocks except the last one have the same size. Those skilled in the art should understand, the sizes of block, piece and subpiece are all exemplary and are non-restrictive.

According to an embodiment of the present invention, the first device 601 comprises an identity information query means 604 and a second means 605.

The identity information query means 604 is used to query a first server group 100 according to the location information of the file 71, such as its URL, so as to determine the identity information of the file 71.

The second means 605 is used to download the file 71 in P2P network 300 based on P2P technology according to the identity information of the file 71.

According to an embodiment of the present invention, the information stored in the first server group 100 may also comprise the digital abstract value of each block of the file, these digital abstract values are associated with the identity information of the file, i.e. RID, or the location information of the file, i.e. URL.

The identity information query means 604 queries the first server group 100, so as to determine the digital abstract value of each block of the file 71 as well as the identity information of the file 71.

The second means 605 downloads the file 71 based on P2P technology in the P2P network 300, wherein the downloading device 600 verifies the accuracy of each downloaded block according to the determined digital abstract value of each block. If the verification passes, the downloading device 600 stores the downloaded block, and continues the download until the whole file 71 is downloaded.

The downloading device 600 carries out the verification on each downloaded block, when the amount of the blocks with mismatch reaches a predetermined value, such as 5, the downloading device 600 will abandon the download in P2P network, since the index information stored in the first server group 100 is determined as wrong. Then, the downloading device 600 will download the whole file 71 all over again from the server 44 according to the location information of the file 71, and update the identity information and the digital abstract value of each block according to the newly downloaded file 71, and report the updated information to the first server group 100. The first server group 100 will update the stored index information according to the information.

According to an embodiment of the present invention, the first server group 100 stores the index information from the digital abstract value of the content of a predetermined length of the file header and the file length to the identity information. The first means 602 downloads the content of a predetermined length of the file header from the server 44 according to the location information, and determines the digital abstract value of the header content as well as the file length, and queries the first server according to the digital abstract value of the header content and the file length, so as to determine the identity information of the file 71. Usually, such operation occurs in the situation that the location information of the file and the file content do not match or their correspondence changes.

According to an embodiment of the present invention, the first server group 100 can be divided into multiple clusters, the index information stored in each cluster of the first servers is associated with distinguishing files, and each cluster of the first servers comprises at least one first server. For example, the first server group 100 comprises two clusters, the first cluster comprises a first server 101, and the second cluster comprises a first server 102. A method of dividing the index information is as follows: calculate the result modulus value of the digital abstract value of the file modulo n, wherein n represents the amount of clusters of the first server group 100; the index information associated with the digital abstract value whose result modulus value equals to 0 is stored in the first cluster of the first server; the index information associated with the digital abstract value whose result modulus value equals to 1 is stored in the second cluster of the first server; and so on, and the index information associated with the digital abstract value whose result modulus value equals to n−1 is stored in the n-th cluster of the first server. In this manner, the index information related to all the files is evenly stored in each cluster of the first server, therefore the payload of a single first server is reduced, and the whole first server group 100 takes the responsibility of query of the index information. Those skilled in the art should understand, the manner of partition of the first server group 100 into multiple clusters, the amount of servers in each cluster, and the storage of the index information in clusters are all exemplary and are non-restrictive.

According to an embodiment of the present invention, the downloading device 600 further comprises a file related information determining means, which is used to determine the identity information and other related information of the file 71, such as the location information of the file 71, the digital abstract value of the content of a predetermined length of the header of the file 71 and the length information of the file 71, etc, and to provide the information to the first server group 100. The first server group 100 establishes kinds of index relationship related to file 71 according to the above information.

According to an embodiment of the present invention, the second means 605 comprises a node indexing means 606 and a third means 607.

The node indexing means 606 will query the second server group 200 according to the identity information of the file 71, such as the digital abstract value of the whole file, so as to obtain the addressing information of other node that possesses the whole or part content of the file 71.

The third means 607 is used to: if other nodes that possess the whole or part content of the file 71 exist, download the file 71 from these other nodes according to the addressing information, based on P2P technology.

The second server group 200 is used for user indexing, and it stores the user index table related to the files. The user index table related to a file comprises the identity information of the file and the addressing information of the user nodes that possess the whole or part of the contents of the file. The user node 301 indexes other user nodes that possess the file 71 in the P2P client network 300 via the second server group 200 and carries out the download according to the result of the indexing.

According to an embodiment of the present invention, the second server group 200 is divided into multiple clusters, each cluster of the second servers is used to index the user node that possess distinguishing files respectively. To be specific, the amount of clusters of the second servers can be equal to that of the first severs, and each cluster of the second servers corresponds to a cluster of first servers respectively. The dividing of the user index table in the second server can apply the same dividing method as that for the index information in the first server, for example, calculating the result modulus value of the digital abstract value of the file modulo n, wherein n represents the amount of clusters of the second server group 200; the user index table associated with the file whose result modulus value of the digital abstract value equals to 0 is stored in the first cluster of the second server; the user index table associated with the file whose result modulus value of the digital abstract value equals to 1 is stored in the second cluster of the second server; and so on, and the user index table associated with the file whose result modulus value of the digital abstract value equals to n−1 is stored in the nth cluster of the second server. In this manner, the user index tables of all the files are evenly stored in each cluster of the second servers, therefore the payload of a single second server is reduced, and the whole second server group 200 takes the responsibility of user indexing.

Each cluster may comprise a plurality of second servers. For example, the first cluster of the second servers comprises servers 201, 202 and 203, which correspond to the first cluster of first servers; the second cluster of the second servers comprises servers 211, 212 and 213, which correspond to the second cluster of first servers; and the n-th cluster of the second servers comprises servers 2(n−1)1, 2(n−1)2 and 2(n−1)3, etc. For the first cluster of the second servers, each sever 201, 202 and 203 therein can be set in different network areas; therefore, the user node resides in one network area may preferably choose to query the second server in the area for the user index table, so as to save the resources of the whole network. Other clusters of second server can apply similar configuration.

Since the files possessed by the user node change with time, correspondingly, the user index table in the second server group 200 may need to be updated with time.

One feasible solution is that each user node reports to the second server the identity information of the files that it possesses termly or periodically. Wherein, all the files in the user node are divided according to the same dividing method as that in the second server. The downloading device 600 in the user node further comprises a reporting means, which is used to report the information related to the existence and update of each cluster of files to each cluster of the second servers. For example, the user node 301 possess the complete or part of the contents of file 71 to file 75, wherein the user index tables of files 71, 73 and 75 are stored in the first cluster of the second servers, and the user index tables of files 72 and 74 are stored in the second cluster of the second servers; the user node 301 can select a second server from the first cluster, such as 201, and select a second server from the second cluster, such as 211, and reports periodically to the two selected second servers; the reported contents may comprise the identity information of the files that belong to the cluster and are possessed by the user node 301, for example, the report sent to the second server 201 comprises the digital abstract values of files 71, 73 and 75, and the report sent to the second server 211 comprises the digital abstract values of files 72 and 74. The second server maintains and updates its stored user index tables according to the received report.

Preferably, the reporting means in the downloading device 600 of each user node periodically reports to the second server the variation of the files that it possesses, which is, reporting the increment. The report sent by the reporting means to the second server 201 only needs to indicate the files which have changed compared with that at last report time; the reported variation information can comprise the digital abstract value of the file and a related identifier that indicates addition/delete, for example, number 0 or 1. The second server carries out the maintenance or update according to the received variation information and the stored user index table. When the amount of the files that the user node possesses is big, the method of reporting the increment can remarkably decrease the overhead for report.

When the reporting means of the user node 301 reports to the selected second server in a cluster of the second servers, for example, the second server 201 in the first cluster, the reported information and the contents of the user index table stored in the second server 201 may not match each other and error occurs. When the duration for the continuous errors has exceed a predetermined duration, the downloading device 600 of the user node 301 may reselect a second server from the first cluster, for example, second server 202, and reports to server 202 the identity information or variation information of the files that belong to the second cluster and are possessed by the user node.

Those skilled in the art should understand that, the report manner of the user node and the manner for updating the user index table in the second server are all exemplary and are non-restrictive.

In order to allow the access from the WAN, the downloading device 600 of the user node 302 can select a node with global address, such as the stun server 88, and informs the stun server 88 of the endpoint of intranet of the user node 302, 10.0.0.1:7777 for example, and the endpoint of the public network of NAT server 82 related the user node 302, 222.0.0.1:8888 for example. The downloading device 600 of the user node 302 may termly send the message to the stun server 88, for example, every 15 seconds; the stun server 88 can feedback messages to the user node 302 with a longer interval, for example, every two minutes; therefore, the stun connection can be maintained. In this manner, the access to the second user node 302 from the WAN could be allowed via the forwarding of the stun server 88. The addressing information that the downloading device 600 of the user node 302 reports to the second server group 200 and is stored in the second server group 200 comprises: the endpoint of intranet of the user node 302, the endpoint of the public network of the NAT server 82 and the endpoint of the stun server 88, 200.0.0.8:9000 for example.

Alternatively, the stun server 88 selected by the user node 302 is a user node with global address, and is equipped with downloading device 600.

The downloading device 600 of the user node 301 uses an endpoint of intranet, 10.0.0.2:7007 for example, to communicate with other nodes. The downloading device 600 of the user node 301 get access to the WAN via an endpoint of public network of the NAT server 81 related to the endpoint of intranet, 233.0.0.1:8000 for example.

The node indexing means 606 of the user node 301 can index the addressing information of the user node 302 from the second server group 200. The user node 301 downloads the file 71 from the P2P network, for example, it downloads contents of the file 71 from the user node 302.

Firstly, the third means 607 of the user node 301 will send a message 511 to the stun server 88 for requesting to establish P2P connection with the user node 302. The message 511 should comprise the endpoint of intranet of the user node 302, 10.0.0.1:7777 for example, and the endpoint of the public network of the related NAT server, 222.0.0.1:8000 for example.

Then, the stun server 88 will send a message 521 to the user node 302. The message 521 comprises the addressing information of the user node 301. After receiving the message, the user node 302 is aware that the user node 301 tries to establish connection with it.

Then, the user node 302 will send a message 531 to the user node 301 for requesting to establish connection with the user node 301.

If the third means 607 of the user node 301 can receive the message 531. Then, the connection between the user nodes 301 and 302 is established, and the user node 301 can download the contents of the file 71 from the user node 302.

In the embodiment, the user node 301 is an intranet user, and the path from the endpoint 222.0.0.1:8000 of the public network of the NAT server related to the endpoint 10.0.0.1:7777 of intranet of the user node 302 to the user node 301 is not open, the NAT server 81 may discard the message 531, and the connection between the user node 301 and 302 still can not be established. Preferably, when the third means 607 of the user node 301 sends the message 511 to the stun server 88, meanwhile, it also sends a handshake message 512 to the NAT server 82, the message 512 comprises the endpoint of the public network of the NAT server 82, i.e. 222.0.0.1:8000, so as to set up the connection between the endpoint of the public network and the user node 301. Then, when the user node 302 sends the message 531 via the endpoint of the public network of the server 82, the NAT server 81 will forward the message 531 to the user node 301 via the open connection. Therefore, the connection between the user node 301 and user node 302 is established, and the user node 301 can download content of the, file 71 from the user node 302.

Those skilled in the art should understand, the so-called means in the present invention can be realized with software functional module, hardware module, or the combination of software and hardware.

Those skilled in the art can understand that the above-described embodiments are for purpose of illustration only, and not construed as limitation of the invention. Different technical features in different embodiments can be combined to obtain beneficial effect. Those skilled in the art could understand and realize modifications to the disclosed embodiments, through studying the description, drawings and appended claims. The word “comprising” does not exclude the presence of elements or steps not listed in the claim or in the description. The word “a” or “an” preceding an element does not exclude the presence of a plurality of such elements. The words “first”, “second” are used to distinguishing the name, and are not used to represent specific order. The reference signs in the claims shall not be construed as limiting the claim. The functions of the plurality of the components in the claims can be realized by a single hardware or software module. Some technical features appear in the dependent claims, however, it does not mean that these technical features can not be combined to obtain beneficial effect.

1. A method in a user node of downloading files, comprising:
A. intercepting a request message from an application functional entity, for requesting a file based on a first protocol;
B. downloading said file at least based on a second protocol; and
C. providing said file to said application functional entity.

2. The method according to claim 1, wherein said request message comprises the location information of said file; said step B further comprises:
B1. querying a first server, so as to determine the identity information of said file according to said location information of said file; and
B2. downloading said file according to said identity information of said file based on P2P technology in a P2P network.

3. The method according to claim 2, wherein said file is partitioned into at least one block based on the features of the first protocol, each block comprises multiple pieces, each piece comprises multiple subpieces; said downloading in the step B2 is conducted in subpieces based on P2P technology.

4. The method according to claim 3, wherein said step B further comprises:
downloading said file in pieces based on said first protocol.

5. The method according to claim 2, wherein said step B2 further comprises:
B21. querying a second server according to said identity information of said file, so as to obtain the addressing information of other nodes that possess said file; and
B22. if other P2P nodes that possess the file exist, downloading said file from said other P2P nodes according to said addressing information, based on P2P technology.

6. The method according to claim 1, wherein said first protocol comprises Hyper Text Transport Protocol or File Transport Protocol, said second protocol comprises protocols based on P2P technology.

7. The method according to claim 5, wherein the index information stored in said first server comprises at least one of the following items:
the index from said location information to said identity information, the index from the digital abstract value of the content of a predetermined length of the file header and the file length to the identity information, the index from the identity information to the location information.

8. The method according to claim 7, wherein said index information stored in said first server comprises the index from the digital abstract value of the content of a predetermined length of the file header and the file length to the identity information; said step B comprises:
downloading said content of a predetermined length of the file header and determining said digital abstract value of said header content and said file length according to said location information, and querying said first server according to said digital abstract value of said header content and said file length so as to determine the identity information of said file.

9. The method according to claim 2, wherein said first servers are divided into multiple clusters and the information stored in each cluster of said first servers is associated with distinguishing file identity information.

10. The method according to claim 9, wherein further comprising:
determining said identity information and other related information of said file and providing said identity information and said other related information to said first server.

11. The method according to claim 5, wherein said second servers are divided into multiple clusters and each cluster of said second servers is used to index nodes possessing distinguishing files, said method further comprises:
reporting the variation information of the files that said user node possesses or the information of all the files that said user node possesses periodically to each cluster of second servers.

12. The method according to claim 5, wherein said step B22 comprises downloading said file from a second user node; said second user node is an intranet user, whose addressing information comprises: the endpoint of the intranet, the endpoint of the public network of the NAT server, and the endpoint of the public network of the stun server associated with said second user node; said step B22 comprises:
i. sending a P2P connection request message to the stun server associated with said second user node, said request message comprising the endpoint of the intranet of the second user node, endpoint of the public network of the NAT server of the second user node; and
ii. receiving the message related to the P2P connection from said second user node, so as to establish P2P connection.

13. The method according to claim 12, wherein said user node is an intranet user, said method further comprises a step before said step ii:
sending a P2P connection request message to the NAT server of the second user node, said request message comprising the endpoint of the public network of the NAT server of said second user node.

14. The method according to claim 5, wherein said user node is an intranet user, said method further comprises:
selecting a stun server and notifying said stun server of the endpoint of the intranet of said user node, endpoint of the public network of the NAT server of said user node.

15. The method according to claim 12, wherein said stun server is a user node.

16. The method according to claim 2, wherein said step B1 comprises: obtaining the identity information of said file and the digital abstract value of each block from said first server;
said method further comprises:
if the amount of the blocks with mismatch between the digital abstract value calculated according to the downloaded block and that obtained from said first server reaches a predetermined number, intactly redownloading said file according to the location information of said file, updating the identity information of said file and the digital abstract value of each block according to said redownloaded file, and reporting said updated identity information of said file and said digital abstract value of each block to said first server.

17. A downloading device in a user node for file download, comprising:
a first obtaining means configured to intercept a request message from an application functional entity, for requesting a file based on a first protocol;
a first means configured to download said file at least based on a second protocol; and
a first providing means, configured to provide said file to said application functional entity.

18. The downloading device according to claim 17, wherein said request message comprises the location information of said file;
said first means further comprises:
an identity information querying means configured to query a first server, so as to determine the identity information of said file according to said location information of said file; and
a second means, configured to download said file according to said identity information of said file based on P2P technology in a P2P network.

19. The downloading device according to claim 18, wherein said file is partitioned into at least one block based on the features of the first protocol, each block comprises multiple pieces, each piece comprises multiple subpieces; said downloading in the step B2 is conducted in subpieces based on P2P technology.

20. The downloading device according to claim 19, wherein said first means is further configured to download said file in pieces based on said first protocol.

21. The downloading device according to claim 17, wherein said second means further comprises:
a node indexing means configured to query a second server according to said identity information of said file, so as to obtain the addressing information of other nodes that possess said file; and
a third means, configured to if other P2P nodes that possess the file exist, downloading said file from said other P2P nodes according to said addressing information, based on P2P technology.

22. The downloading device according to claim 17, wherein said first protocol comprises Hyper Text Transport Protocol or File Transport Protocol, said second protocol comprises protocols based on P2P technology.

23. The downloading device according to claim 21, wherein the index information stored in said first server comprises at least one of the following items:
the index from said location information to said identity information, the index from the digital abstract value of the content of a predetermined length of the file header and the file length to the identity information, the index from the identity information to the location information.

24. The downloading device according to claim 23, wherein said index information stored in said first server comprises the index from the digital abstract value of the content of a predetermined length of the file header and the file length to the identity information; said first means is further configured to:
download said content of a predetermined length of the file header and determining said digital abstract value of said header content and said file length according to said location information, and querying said first server according to said digital abstract value of said header content and said file length so as to determine the identity information of said file.

25. The downloading device according to claim 18, wherein said first servers are divided into multiple groups and the information stored in each cluster of said first servers is associated with distinguishing file identity information.

26. The downloading device according to claim 25, further comprising:
File related information determining means, configured to determine said identity information and other related information of said file and to provide said identity information and said other related information to said first server.

27. The downloading device according to claim 21, wherein said second servers are divided into multiple groups and each cluster of said second servers is used to index nodes possessing distinguishing files, said download device further comprises:
a reporting means configured to report the variation information of the files that said user node possesses or the information of all the files that said user node possesses periodically to each cluster of second servers.

28. The downloading device according to claim 21, wherein the operation carried out by the said third means comprises downloading said file from a second user node; said second user node is an intranet user, whose addressing information comprises: the endpoint of the intranet, the endpoint of the public network of the NAT server, and the endpoint of the public network of the stun server associated with said second user node; said third means is further configured to:
send a P2P connection request message to the stun server associated with said second user node, said request message comprising the endpoint of the intranet of the second user node, endpoint of the public network of the NAT server of the second user node; and
receive the message related to the P2P connection from said second user node, so as to establish P2P connection.

29. The downloading device according to claim 28, wherein said user node is an intranet user, said downloading device is further configured to:
send a P2P connection request message to the NAT server of the second user node, said request message comprising the endpoint of the public network of the NAT server of said second user node.

30. The downloading device according to claim 21, wherein said user node is an intranet user, said downloading device is further configured to:
select a stun server and notify said stun server of the endpoint of the intranet of said user node, endpoint of the public network of the NAT server of said user node.

31. The downloading device according to claim 28, wherein said stun server is a user node.

32. The downloading device according to claim 18, wherein said identity information querying mean is further configured to obtain the identity information of said file and the digital abstract value of each block from said first server;
said downloading device is further configured to:
if the amount of the blocks with mismatch between the digital abstract value calculated according to the downloaded block and that obtained from said first server reaches a predetermined number, intactly redownloading said file according to the location information of said file, updating the identity information of said file and the digital abstract value of each block according to said redownloaded file, and reporting said updated identity information of said file and said digital abstract value of each block to said first server.

33. The method according to claim 1 further comprising a client side software comprising instructions to realize each step of the respective method.

34. The method according to claim 1 further comprising a storage media for storing the instructions to realize each step of the method.
